(19) United States
(12) Patent Application Publication
(10) Pub. No.: US 2006/0234579 A1
(43) Pub. Date: Oct. 19, 2006

(54) High temperature ceramic-based thermal protection material

(76) Inventors: Steven J. Adam, Orange, CA (US); Peter A. Hogenson, Long Beach, CA (US); James V. Tompkins, Huntington Beach, CA (US); Gordon R. Toombs, Long Beach, CA (US); Douglas G. Soden, San Pedro, CA (US)

Correspondence Address: INGRASSIA FISHER & LORENZ, P.C., 7150 E. CAMELBACK, STE. 325, SCOTTSDALE, AZ, 85251, US

(21) Appl. No.: 11/106,763

(22) Filed: Apr. 14, 2005

(51) Int. Cl. B32B 17/02; B32B 27/12; B32B 27/04

(52) U.S. Cl. 442/136; 442/172; 442/178; 501/88; 501/87; 501/96.1; 501/96.3

(57) ABSTRACT

A thermal protection paste as described herein can be used by itself, or impregnated into a high temperature resistant fabric to form a repair patch, to repair a thermal protection structure. The paste includes a ceramic composition that includes ceramic material having at least a first controlled particle size and a second controlled particle size that is larger than the first controlled particle size. The ceramic composition is mixed into a high temperature ceramic precursor resin to form the paste. The paste (or patch) is applied to the structure under repair and initially heated to cure the paste and to secure it in place. When the paste and/or patch is cured, it becomes a cross-linked polymer having high thermal protection characteristics. When the paste is exposed to very high temperature, e.g., spacecraft reentry temperatures, it pyrolizes and retains its high thermal protection characteristics.

### STATEMENT REGARDING FEDERALLY SPONSORED RESEARCH OR DEVELOPMENT

The invention described herein was made in the performance of work under NASA Contract Number NAS9-20000, Sub Contract Number 1970438303, and is subject to the provisions of Section 305 of the National Aeronautics and Space Act of 1958 (72 Stat. 435: 42 U.S.C. 2457).

### TECHNICAL FIELD

The present invention relates generally to thermal protection materials. More particularly, the present invention relates to a high temperature ceramic-based thermal protection paste.

### BACKGROUND

The prior art is replete with thermal protection shields, materials, and systems designed to protect a variety of structures from damage due to high temperatures. For example, spacecraft, aircraft, and missiles may incorporate thermal protection structures for protection against high temperatures caused by atmospheric friction resulting from the tremendous velocities experienced during travel or reentry. In some situations it may be desirable to repair a thermal protection system of an orbiting spacecraft in preparation for reentry (the vibration and stress associated with the launching of a spacecraft may damage the thermal protection system, resulting in small cracks and/or holes in some thermal protection structures).

Thermal protection patches and compounds that employ ceramic materials are generally known. Conventional thermal patches utilize a thermal protection paste or compound applied to a fabric formed of a ceramic material. Such thermal protection patches, however, can require excessive curing times, high curing temperatures, or otherwise be unsuitable for deployment on an orbiting craft. In addition, known thermal protection patches employ a compound or paste that incorporates a ceramic powder having a uniform particle size. The use of a single ceramic particle size may not provide the best thermal protection for long periods of time, due to the presence of interstices and voids between the ceramic particles.

Accordingly, it is desirable to have a portable, efficient, and effective repair patch for a high temperature thermal protection system. In addition, it is desirable to have a curable repair paste and patch that can improve the durability, reliability, and useful life of thermal protection systems deployed on an aircraft or spacecraft. Furthermore, other desirable features and characteristics of the present invention will become apparent from the subsequent detailed description and the appended claims, taken in conjunction with the accompanying drawings and the foregoing technical field and background.

### BRIEF SUMMARY

A curable thermal protection paste as described herein can be utilized to repair a thermal protection structure of an aircraft, a spacecraft, or any device, system, or vehicle exposed to very high temperatures. The paste may be impregnated in a ceramic-based fabric to form a repair patch that can be installed on an orbiting craft or structure. The paste includes a controlled amount of material (e.g., ceramic material) having at least two different particle sizes, which results in a more homogeneous dispersion of ceramic material throughout the repair patch, relative to conventional repair patches.

The above and other aspects of the invention may be carried out in one form by a curable thermal protection material comprising a high temperature ceramic precursor resin and a ceramic composition blended in the high temperature ceramic precursor resin. The ceramic composition includes a first amount of a ceramic material in a first controlled particle size, and a second amount of the same ceramic material in a second controlled particle size, where the second controlled particle size is larger than the first controlled particle size.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a perspective view of a thermal protection structure with a repair patch affixed thereto;

FIG. 2 is a bottom view of an example thermal protection patch;

FIG. 3 is a cross sectional side view of an example thermal protection patch installed on a repaired structure; and

FIG. 4 is a flow chart of a patch formation process according to an example embodiment of the invention.

### DETAILED DESCRIPTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description. For the sake of brevity, conventional aspects and characteristics of high temperature ceramic materials, high temperature resins, high temperature fabrics, thermal protection systems and structures for aircraft and spacecraft, and other aspects of thermal protection patches (and the individual components of the patches) may not be described in detail herein.

Although the following description focuses on thermal protection systems for spacecraft and aircraft, the invention is not so limited. Indeed, the thermal protection paste, patch, and material described herein may also be utilized in connection with one or more of the following alternative applications, without limitation: combustion chambers of rocket motors; high temperature nozzles; hot gas ducting; heat exchangers; jet engines; space power systems; ordinance; terrestrial power generation systems; kilns; or any application where heat protection is desired.

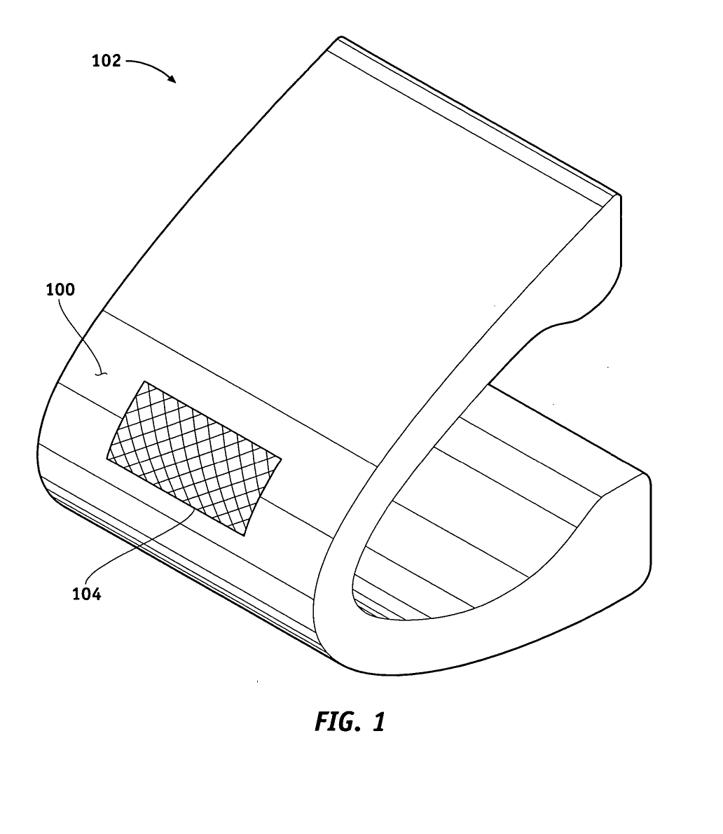

Recent discoveries related to the durability of thermal protection systems deployed on spacecraft have highlighted the need for the capability to repair thermal protection structures and materials while in orbit. For example, return-to-flight efforts for the Space Shuttle program have addressed a repair methodology for holes or cracks that might appear in the reinforced carbon-carbon (“RCC”) composite wing structure after launch. In this regard, FIG. 1 is a perspective view of a thermal protection structure 100 on the leading edge of a wing structure 102. The leading edge is exposed to extreme heat caused by atmospheric friction during reentry or flight. Therefore, thermal protection structure 100 is preferably utilized at the leading edge. FIG. 1 also depicts a thermal protection patch 104 that serves as a repair patch for thermal protection structure 100. FIG. 1 shows thermal protection patch 104 adhered to thermal protection structure 100; this may represent a state before or after initial curing of thermal protection patch 104 as described herein.

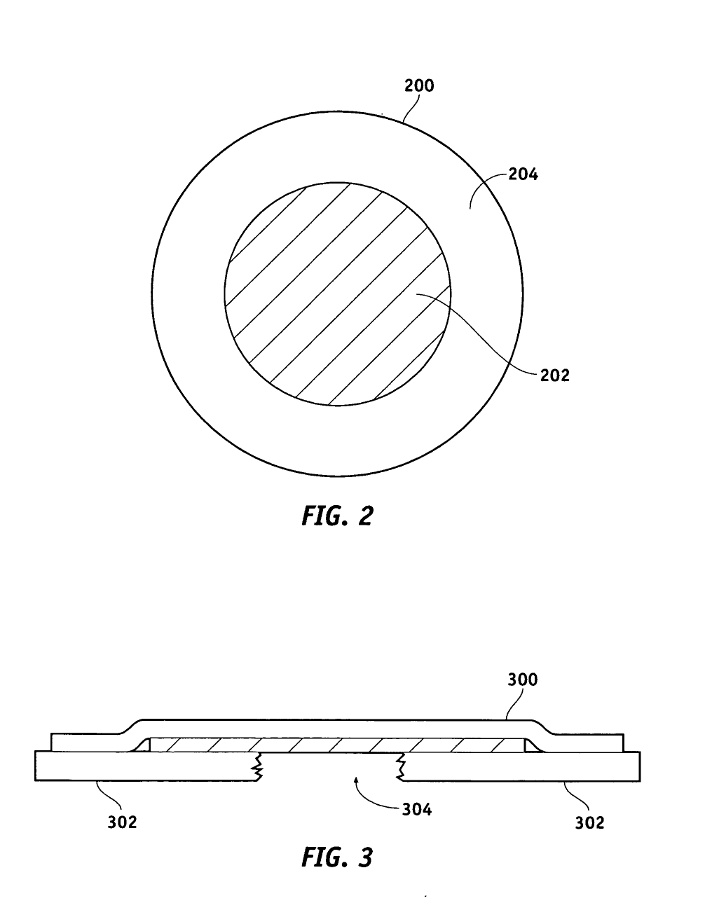

FIG. 2 is a bottom view of a typical multi-layer thermal protection patch 200, which may be configured in accordance with an example embodiment of the invention as described herein. Thermal protection patch 200 includes a bottom layer 202 covered by at least one upper layer 204. In practical embodiments, bottom layer 202 is smaller than upper layer 204 such that upper layer 204 overlaps bottom layer 202 as shown in FIG. 2. It should be appreciated that the shape and size of the thermal protection patch can vary to suit the needs of the given repair, and that the round thermal protection patch 200 shown in FIG. 2 is merely one example embodiment.

FIG. 3 is a cross sectional side view of an example thermal protection patch 300 installed on a repaired structure 302. In this example, repaired structure 302 has a hole 304 therein, and thermal protection patch 300 is installed to cover hole 304. Thermal protection patch 300 includes a bottom layer 306 that is preferably sized and shaped to completely overlap hole 304. Thermal protection patch 300 also includes at least one upper layer 308 that is preferably sized and shaped to completely overlap bottom layer 306.

In a practical deployment, the repair technique must be simple enough for an astronaut to perform during a spacewalk, it should not require large amounts of power, and the repaired structure must be able to withstand reentry temperatures of up to approximately 3000° F. for extended periods of time. In addition, the repair technique should require little, if any, access to structural components located under the RCC panels, and the repair technique must not generate temperatures that are high enough to damage the RCC panels.

As described herein, the invention contemplates a number of possible formulations of a thermal protection paste and adhesive material that can be used for thermal protection of a structure or component, for example, as a constituent of a repair patch. Generally, the paste is based upon a ceramic precursor resin or preceramic polymer, which is then converted into a cross-linked polymer having ceramic qualities and characteristics upon heat curing. In certain aerospace applications, the high temperature experienced during reentry may pyrolyze the cured paste, however, the thermal protection remains intact.

Although the thermal protection paste and patch described herein are not limited to any particular application or use, they are suitable for use in the repair of thermal protection structures deployed on spacecraft such as the Space Shuttle. As described in more detail below, one preferred approach is to apply a suitable repair patch (which includes a high temperature reinforced fabric impregnated with a ceramic-based thermal protection paste) to the damaged structure, and heat cure the repair patch. In a spacecraft application, the heat curing may occur while the spacecraft is still in orbit. After initial curing, the repaired thermal protection structure is capable of withstanding extremely high reentry temperatures for periods of up to fifteen minutes.

In practice, the thermal protection paste described herein provides a thermal barrier material that can be applied by itself to fill cracks or small voids, or applied to a ceramic-based fabric to form a patch capable of covering larger holes (see FIG. 3). The paste is applied in an uncured and pliable state such that the repair patch can conform to the contour of the structure to be repaired. The paste makes the repair patch viscous and sticky at normal temperatures, allowing the repair patch to stick to the surface to be patched upon contact. In practical applications the repair patch can be relatively thin, which is desirable to prevent the creation of large discontinuities and “forward facing steps” on an otherwise streamlined structure. After the repair patch is attached to the structure, it is heated to cure, converting it from a flexible material to a hard, tough material that will survive the heat of reentry and protect the damaged thermal protection structure. In the preferred embodiment, the paste has a relatively modest initial curing temperature (e.g., 300-450° F.). Thus, the repair patch is simple to apply and has low energy demands.

A curable thermal protection paste according to an example embodiment of the invention generally includes a carrier compound and a ceramic composition blended in the carrier compound, the ceramic composition including at least a first ceramic material having a first controlled particle size, and a second ceramic material having a second controlled particle size that is greater than the first controlled particle size. As used herein, “controlled particle size” means that the particle size is specifically selected in order to achieve the benefits described herein. In preferred practical embodiments, the first ceramic material and the second ceramic material are formed from a common ceramic material, i.e., the thermal protection paste employs a single ceramic material having two different particle sizes. Although the following description focuses on a bi-modal composition, the invention is not so limited and, indeed, a thermal protection paste according to the invention may be any multi-modal composition having any number (including only one) of different materials and having two or more different particle sizes. Furthermore, although the preferred embodiments utilize ceramic particles for the thermal protection paste, alternate embodiments may utilize metallic particles and/or other suitable particles that are able to withstand extreme temperatures.

The carrier compound may be any suitable high temperature ceramic precursor resin or preceramic polymer, such as a liquid polysilazane or a silazane-based polymer, and a number of appropriate resins and polymers are commercially available. In this regard, the thermal protection paste may utilize conventional branded resins or polymers, including, without limitation: KION® VL20; the CERASET® family of resins; and polymers available from STARFIRE SYSTEMS. The properties, characteristics, and compositions of such resins and polymers are known to those skilled in the art and, therefore, will not be described in detail herein. In practice, the particular carrier compound for a given thermal protection paste may be selected for compatibility with the intended ceramic composition or material incorporated into the paste. For example, one resin may be particularly compatible with silicon carbide while another resin may be particularly compatible with zirconium boride.

As mentioned above, the ceramic composition of the thermal protection paste is preferably (but need not be) formed from a single ceramic material having a plurality of different controlled particle sizes. In practice, the ceramic composition resembles a fine powder, and the ceramic powder is blended into the carrier compound to form the paste. It should be appreciated that different materials may be employed, depending upon the maximum temperature rating for the thermal protection paste. For example, some ceramic or metallic materials may be suitable for use with relatively high temperature applications (e.g., temperature rating of 3500° F.), while other ceramic or metallic materials may be suitable for use with relatively low temperature applications (e.g., temperature rating of 2500° F.).

For relatively high temperature applications, the thermal protection paste may incorporate one or more of the following materials, without limitation: silicon carbide; hafnium carbide; zirconium carbide; niobium carbide; tungsten carbide; tungsten dicarbide; hafnium oxide; zirconium oxide; silicon dioxide; silicon nitride; hafnium nitride; zirconium nitride; niobium boride; silicon tetraboride; silicon hexaboride; titanium diboride; tungsten diboride; zirconium diboride; zirconium orthosilicate; calcium oxide; strontium oxide; thorium dioxide; calcium metazirconate; metal powders (Ta, W-Re, Mo); silicides (WSi, TaSi₂, MoSi₂); carbon or BN nanotubes; aluminum oxide; and other oxides (ytteria, zirconia, ceria, Ta₂O₅, niobium oxide). For relatively low temperature applications, the thermal protection paste may incorporate any of the materials identified above, and/or at least one of the following materials, without limitation: barium hexaboride; strontium hexaboride; thorium hexaboride; and boron carbide. A thermal protection paste composition according to a preferred embodiment of the invention includes one or more of the following materials: silicon carbide, zirconium oxide, hafnium oxide, hafnium carbide, zirconium carbide, zirconium boride, silicon tetraboride, silicon hexaboride, aluminum oxide, or yttrium oxide.

In the preferred embodiment, the particle size of the ceramic/metal material can range from approximately 0.01 microns to approximately 10 microns. In practice, however, the ceramic particle size may be outside of this range, depending upon the application. As mentioned above, a bi-modal embodiment includes ceramic particles having two different sizes. One example bi-modal thermal protection paste incorporates ceramic material having first and second controlled particle sizes, where the second particle size is at least five times the first particle size, and preferably approximately ten times the first particle size. Although the smaller particle size should be about 10 times smaller than the larger particle size, it can be anywhere between 5-12 times smaller in a practical embodiment. For example, if the first particle size is about one micron, the second particle size is about ten microns. A preferred tri-modal thermal protection paste might have a ceramic composition including ceramic material having particles sizes in the ratio of 1:10:100, for example, a first particle size of about 0.01 microns, a second particle size of about 0.1 microns, and a third particle size of about one micron. Again, the invention is not limited to any number of different particle sizes, and a practical embodiment might have more than three different particle sizes.

Notably, the amount of ceramic material having the first controlled particle size is unequal to the amount of ceramic material having the second controlled particle size. In this regard, the thermal protection paste includes unequal parts by weight of ceramic material of the smaller particle size relative to the ceramic material of the larger particle size. Preferably, the weight of ceramic material of the larger particle size is greater than the weight of ceramic material of the smaller particle size. This unequal weight ratio is desirable to allow the smaller ceramic particles to effectively enter the voids and interstices between the larger ceramic particles suspended in the carrier compound.

In accordance with example embodiments of the invention, the thermal protection paste includes between approximately 15-45 parts by weight of the smaller ceramic particles, and between approximately 25-80 parts by weight of the larger ceramic particles. The particular mix of the ceramic composition can vary to suit the needs of the particular application (e.g., to satisfy the thermal requirements, provide the desired viscosity, provide the desired adhesion, etc.).

The amount of ceramic composition relative to the carrier compound can also vary to suit the requirements of the given application. In practice, the thermal protection paste includes more of the ceramic composition (by weight) than the carrier compound. In accordance with example embodiments of the invention, the thermal protection paste includes between approximately 50-85 parts by weight of the ceramic composition (which is a combination of the different sized ceramic particles), and between approximately 15-45 parts by weight of the carrier compound.

As mentioned above, the thermal protection paste may be applied onto or impregnated into a ceramic-based fabric to create an adhesive repair patch for a thermal protection structure. In practice, the type of fabric in the patch and the composition of the paste will depend upon the composition of the structure under repair. For example, if the thermal protection structure to be repaired is formed from alumina, then an alumina-based fabric and an alumina-based paste should be utilized. In other words, the ceramic-based fabric preferably includes a component formed from the same ceramic material incorporated into the thermal protection paste.

For relatively high temperature applications, the fabric may include one or more of the following, without limitation: TYRANO™ SA-8 (silicon carbide); HI-NICALON™ (silicon carbide); zirconia fabrics; hafnia fabrics; zirconium carbide fabrics; hafnium carbide fabrics; tantalum fabric; tungsten-rhenium fabric; superalloy fabric (Ti₃AI, NiAl); tantalum foil or other foils; and coated carbon fiber fabric. For relatively low temperature applications, the fabric may include any of the fabrics identified above, and/or at least one of the following, without limitation: NEXTEL™ 440 (alumina); NEXTEL™ 710 (alumina); alumina fabrics; silica fabrics; and boron carbide fabrics.

A simple thermal protection patch utilizes two layers of fabric impregnated with a single paste composition (see FIG. 2 and FIG. 3). Other patches may utilize multiple fabric layers (including the same fabric or different fabrics) and multiple paste layers (including the same paste composition or different paste compositions). In the example spacecraft application described herein, relatively thin, two-layer, single paste patches are preferred. For such applications, the overall thickness of the patch is usually less than 0.10 inches. Of course, thicker patches can be produced if desired.

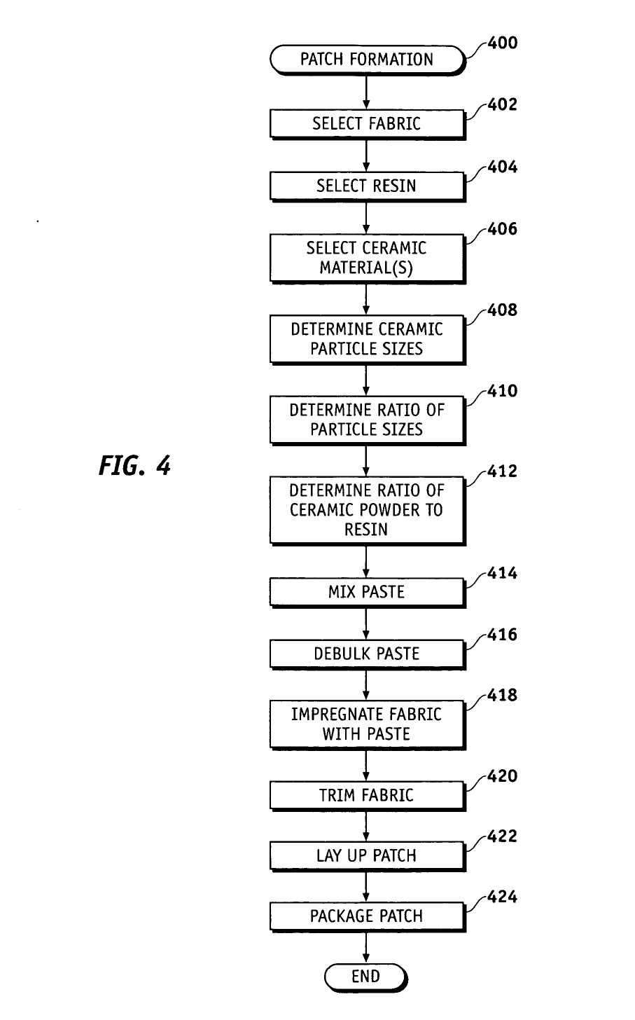

FIG. 4 is a flow chart of a patch formation process 400 according to an example embodiment of the invention. The various tasks performed in connection with process 400 may be performed to produce a thermal protection patch as described herein to suit the requirements of a given application. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein.

Patch formation process 400 begins by selecting a suitable fabric (task 402), a suitable carrier compound such as a resin (task 404), and a suitable ceramic material or materials (task 406). As described above, the selection of these constituent components may be dictated by the requirements of the particular application. Once the ceramic material is selected, the different sizes of the ceramic particles are determined (task 408), along with the desired weight ratio of the particle sizes (task 410). In addition, the desired weight ratio of ceramic composition to resin is determined (task 412), resulting in the preferred “recipe” for the thermal protection paste.

The ceramic composition may then be blended together in the specified weight ratio. In practice, the ceramic composition will take the form of a fine powder. Next, the appropriate amount of the mixed ceramic composition is blended into the appropriate amount of resin, and the resulting paste is mixed (task 414). In practice, the paste is mixed for approximately thirty minutes to ensure that all of the ceramic particles are uniformly dispersed in the resin. Thereafter, the homogenized paste may be debulked (task 416) by exposing it to a vacuum environment for approximately thirty minutes to remove air bubbles from the paste. After debulking, the thermal protection paste should have the desired viscosity and adhesiveness.

Next, the paste is applied to and then impregnated into the high temperature fabric (task 418) using a roller and pressure to thoroughly wet the fabric. The impregnated fabric can then be trimmed into the desired shapes and sizes for each layer (task 420). Thereafter, the layers of the patch can be assembled with a suitable lay up procedure (task 422). If necessary, the patch can be trimmed and packaged with release sheets in a sealed bag, wrapping, or container (task 424). Such packaging is particularly desirable to accommodate repairs to spacecraft in orbit—the packaging makes the thermal protection patch portable and protects the patch from drying and contamination in transit.

As described above, the specific composition of the thermal protection paste and the repair patches may vary according to the particular application. Nonetheless, a number of practical examples are set forth below. These examples are merely illustrative in nature, however, and do not limit or restrict the scope of the invention in any way. In the following examples, the unit “grit” is approximately equal to the unit “mesh,” which equals the number of openings per linear inch. Although there is not direct correlation between mesh and microns, a 1000 grit powder has a nominal particle size of 10 microns.

Example 1—Simple Mono-Modal Paste Patch

Standard 800 grit paste was made by mixing 60 parts by weight of 800 grit silicon carbide with 25 parts by weight of KION VL-20 or STARFIRE resin, mixing the paste thoroughly, and de-bulking the paste for 30 minutes in a vacuum dessicator. The paste was applied to either TYRANO SA-8 fabric or HI-NICALON fabric, and impregnated into the fabric. The fabric was cut into circular pieces of the desired size and the fabric layers were placed on top of one another to make a two or three layer patch. The top of each patch was “dusted” with approximately 0.58 g/in² of 800 or 1000 grit silicon carbide to form a hard protective top shell following cure. The patch was cured at 400° F. for three hours, then passed an arc-jet torch test for 15 minutes at 230 BTU.

Example 2—Bi-Modal Paste Patch

This experimental bi-modal paste was made by mixing 47.1 grams of 800 grit silicon carbide, 23.5 grams of 0.13 micron silicon carbide, and 29.4 grams of KION VL-20 resin, mixing the paste thoroughly, and de-bulking the paste for 30 minutes in a vacuum dessicator. The paste was applied to TYRANO SA-8 fabric and impregnated into the fabric. The fabric was cut into circular pieces of the desired size. The impregnated fabric layers were placed on top of one another to make a two layer patch. The patch was cured at 400° F. for three hours, then passed an arc-jet torch test for 15 minutes at 230 BTU.

Example 3—Bi-Modal Submicron Paste Patch

This submicron bi-modal thermal protection paste was made by mixing 36 grams of 1.0 micron silicon carbide, 24 grams of 0.13 micron silicon carbide, and 25 grams of KION VL-20 resin, mixing the paste thoroughly, and de-bulking the paste for 30 minutes in a vacuum dessicator. The paste was applied to TYRANO SA-8 fabric and impregnated into the fabric. The fabric was cut into circular pieces of the desired size. The impregnated fabric layers were placed on top of one another to make a two layer patch. The patch was cured at 400° F. for three hours, then passed an arc-jet torch test for 15 minutes at 280 BTU.

Example 4—Bi-Modal Submicron Reverse Formulation Paste With Zirconia Paste Multi-Layer Patch

This submicron reverse formulation bi-modal paste was made by mixing 24 parts by weight of 1.0 micron silicon carbide, 36 parts by weight of 0.13 micron silicon carbide, and 25 parts by weight of KION VL-20 resin. In addition, 75% ZrO₂ paste was made by mixing 45 grams of ZrO_{2,} 15 grams of 0.13 micron silicon carbide, and 25 grams of KION VL-20 resin. Each paste was mixed thoroughly and de-bulked for 30 minutes in a vacuum dessicator. The reverse formulation bi-modal paste was applied to HI-NICALON fabric and impregnated into the fabric. The fabric was cut into circular pieces of the desired size. The impregnated fabric layers were placed on top of one another to make a two layer patch. The 75% ZrO₂ paste was applied to zirconia fabric and impregnated into the fabric. The fabric was cut into a circular piece of the desired size for a top layer. The top layer of ZrO₂ paste with zirconia fabric was placed on top of the two reverse formulation bi-modal paste layers. The patch was cured at 450° F. for three hours, then passed an arc-jet torch test for 15 minutes at 230 BTU.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A curable thermal protection paste comprising:
a high temperature ceramic precursor resin;
a first material blended in said high temperature ceramic precursor resin, said first material having a first controlled particle size; and
a second material blended in said high temperature ceramic precursor resin, said second material having a second controlled particle size that is larger than said first controlled particle size.

2. A curable thermal protection paste according to claim 1, said first material and said second material being formed from a common ceramic material.

3. A curable thermal protection paste according to claim 2, said high temperature ceramic precursor resin being compatible with said common ceramic material.

4. A curable thermal protection paste according to claim 1, further comprising unequal parts by weight of said first material and said second material.

5. A curable thermal protection paste according to claim 4, further comprising between approximately 15-45 parts by weight of said first material and between approximately 25-80 parts by weight of said second material.

6. A curable thermal protection paste according to claim 1, said first material and said second material together forming a ceramic composition, and further comprising between approximately 50-85 parts by weight of said ceramic composition and between approximately 15-45 parts by weight of said high temperature ceramic precursor resin.

7. A curable thermal protection paste according to claim 1, said second controlled particle size being at least five times said first controlled particle size.

8. A curable thermal protection paste according to claim 7, said second controlled particle size being approximately ten times said first controlled particle size.

9. A curable thermal protection patch comprising:
a ceramic-based fabric; and
a curable thermal protection paste applied to said ceramic-based fabric, said curable thermal protection paste comprising:
a high temperature ceramic precursor resin;
a first ceramic material blended in said high temperature ceramic precursor resin, said first ceramic material having a first controlled particle size; and
a second ceramic material blended in said high temperature ceramic precursor resin, said second ceramic material having a second controlled particle size that is larger than said first particle size.

10. A curable thermal protection patch according to claim 9, further comprising unequal parts by weight of said first ceramic material and said second ceramic material.

11. A curable thermal protection patch according to claim 9, said second controlled particle size being at least five times said first controlled particle size.

12. A curable thermal protection patch according to claim 9, said first ceramic material and said second ceramic material being formed from a common ceramic material.

13. A curable thermal protection patch according to claim 12, said ceramic-based fabric comprising a component formed from said common ceramic material.

14. A curable thermal protection material comprising:
a high temperature ceramic precursor resin; and
a ceramic composition blended in said high temperature ceramic precursor resin, said ceramic composition comprising a first amount of a ceramic material in a first controlled particle size, and a second amount of said ceramic material in a second controlled particle size, said second controlled particle size being larger than said first controlled particle size.

15. A curable thermal protection material according to claim 14, further comprising unequal parts by weight of said first amount of said ceramic material and said second amount of said ceramic material.

16. A curable thermal protection material according to claim 14, said second controlled particle size being at least five times said first controlled particle size.

17. A curable thermal protection material according to claim 16, said second controlled particle size being approximately ten times said first controlled particle size.

18. A curable thermal protection material according to claim 14, further comprising a ceramic-based fabric impregnated with said high temperature ceramic precursor resin blended with said ceramic composition.

19. A curable thermal protection material according to claim 18, said ceramic-based fabric comprising a component formed from said ceramic material.

20. A curable thermal protection material according to claim 14, further comprising:
between approximately 15-45 parts by weight of said first amount of said ceramic material;
between approximately 25-80 parts by weight of said second amount of said ceramic material;
between approximately 50-85 parts by weight of said ceramic composition; and
between approximately 15-45 parts by weight of said high temperature ceramic precursor resin.
